(19) United States
(12) Patent Application Publication
(10) Pub. No.: US 2004/0003026 A1
(43) Pub. Date: Jan. 1, 2004

(54) Data management device for precise quality control

(75) Inventor: Atsushi Fukumoto, Hyogo (JP)

Correspondence Address: McDERMOTT, WILL & EMERY, 600 13th Street, N.W., Washington, DC, 20005-3096, US

(73) Assignee: MITSUBISHI DENKI KABUSHIKI KAISHA

(21) Appl. No.: 10/337,393

(22) Filed: Jan. 7, 2003

(30) Foreign Application Priority Data
Jul. 1, 2002 (JP) 2002-192129(P)

(51) Int. Cl. G01N 37/00

(52) U.S. Cl. 709/201

(57) ABSTRACT

A quality control method includes the steps of calculating average X and standard deviation σ of quality control data, excluding abnormal data outside a range represented by (average X±4σ), calculating average X and standard deviation σ of the quality control data except for the abnormal data, determining N in (average X±(2.5+0.1×N)σ) representing a region so that the ratio of the number of data outside the region relative to the number of all data is 0.015 or less, using the calculated N to set alarm standards at (specification center E±(2.5+0.1×N)σ), and preparing quality alarm information when any data is found outside the alarm standards.

### BACKGROUND OF THE INVENTION

1. Field of the Invention

The present invention relates to quality control of industry products. In particular, the present invention relates to a data management device capable of exercising precise quality control based on Shewhart control charts.

2. Description of the Background Art

Various methods have been proposed for controlling the quality of industry products. For example, Shewhart control charts are used to detect variation or fluctuations due to any abnormal cause in a process by setting a dispersion in a group as a standard. According to this method, quality characteristic values are divided into reasonable groups, and then the average and dispersion in each group are calculated to manage variations in the central value and dispersion. The control charts have been used in manufacturing semiconductors to analyze abnormality in quality as well as any change in the tendency of variations, which are addressed immediately in the manufacturing steps. In this way, quality control has been carried out with the minimum number of defective products manufactured. Such quality control using the control charts requires precise processing of quality characteristic values in an enormous amount of sampled data so as to immediately provide correct and accurate information.

Regarding this method of quality control by means of such control charts, processing of the quality characteristic values often relies on manpower. In addition, the amount of sampled data is enormous. Accordingly, there is a limit to the quality control method by means of such control charts as Shewhart control charts, as detailed in the following.

Suppose that an alarm standard is set between a control limit and the center of a specification range. Here, the alarm standard is used for detecting any abnormality in variations of the process. The alarm standard is determined by a person in charge from general analysis of various data. Then, the determination of the alarm standard relies on personal ability. If the determined alarm standard does not satisfactorily reflect actual results of the process, the alarm is issued frequently to hinder the progress of the process. At first, each time the alarm is issued, the cause is investigated and measures are taken accordingly. In due time, a person in charge gets accustomed to the alarm and eventually, no measure is taken for the alarm and the alarm standard could become meaningless. If the alarm standard is alleviated for avoiding this, the number of times the alarm is issued greatly decreases. In such a case, it could erroneously be determined that the process proceeds in a stable manner even if the process is unstable.

Moreover, if the average of industry products deviates from the central value of an allowable specification range, management of the central value often relies on manpower. Then, if the deviation is relatively small and accordingly the average changes within the alarm limits, such a deviation could not be detected and could be left as it is.

### SUMMARY OF THE INVENTION

One object of the present invention is to provide a data management device to facilitate setting of alarm standards of a control chart.

Another object of the present invention is to provide a data management device precisely controlling the central value.

Still another object of the present invention is to provide a data management device automatically exercising precise quality control.

A further object of the present invention is to provide a data management device capable of appropriately issuing an alarm.

According to one aspect of the present invention, a data management device includes a storage unit for storing data, a first calculation unit for calculating average X, standard deviation σ and the number of all data except for abnormal data in the data stored by the storage unit, a second calculation unit for calculating the number of partial data of all the data, the partial data being outside a region of a range defined by a function of the standard deviation σ with the average X as a center, a third calculation unit for calculating a function of the standard deviation σ representing a region where the ratio of the number of the partial data relative to the number of all the data is equal to a predetermined ratio or less, and a first output unit monitoring measured data according to the calculated function of the standard deviation σ for outputting an alarm for the measured data.

The data management device determines a region representing partial data, the ratio of the number of the partial data relative to all the data being equal to a predetermined ratio or less. Here, the region is represented by a function of the standard deviation σ with the average of all the data at the center. The function of the standard deviation σ is used to control the central value of a specification range, for example. According to the predetermined ratio, the first output unit issues an alarm. The alarm is thus appropriately raised based on the function of the standard deviation σ determined from data. Accordingly, the data management device is provided to facilitate setting of alarm standards and automatically control the central value.

Preferably, the first output unit includes a unit for issuing an alarm for measured data when any data is newly present outside the region represented by the calculated function of the standard deviation σ with the specification center as a center.

An alarm is thus raised for data outside the region represented by the function of the standard deviation σ calculated with the specification center as a center. In this case, alarms are appropriately issued for approximately 1.5% to 4.5% of data with respect to the whole data.

Still preferably, the data management device further includes a second output unit for issuing an alarm notifying that there arises a variation in the data when a predetermined number of consecutive time-series data is present on only one of respective sides larger than and smaller than the specification center.

When data concentrates on any one side with respect to the specification center (for example, seven consecutive points of data are smaller than the specification center), an alarm is raised. The trend of variation in data is thus ascertained.

Still more preferably, the data management device further includes a second output unit for issuing an alarm notifying that there arises a variation in the data when at least a predetermined number of consecutive time-series data is present on only one of respective sides larger than and smaller than the specification center.

When concentration of data appears on any one side with respect to the specification center (for example, twelve out of fourteen consecutive points of data are smaller than the specification center), an alarm is raised. The trend of variation in data is thus ascertained.

According to another aspect of the present invention, a data management device includes a storage unit for storing data, a first calculation unit for calculating average X, standard deviation σ and the number of all data except for abnormal data in the data stored by the storage unit, a second calculation unit for calculating the number of partial data of all the data, the partial data being within a region of a range defined by a function of the standard deviation σ with the average X as a center, a third calculation unit for calculating a function of the standard deviation σ representing a region where the ratio of the number of the partial data relative to the number of all the data is equal to a predetermined ratio or more, a first output unit monitoring measured data according to the calculated function of the standard deviation σ for outputting an alarm for the measured data.

The data management device determines a region representing partial data, the ratio of the number of the partial data relative to all the data being equal to a predetermined ratio or more. Here, the region is represented by a function of the standard deviation σ with the average of all the data at the center. The function of the standard deviation σ is used to control the central value of a specification range, for example. According to the predetermined ratio, the first output unit issues an alarm. The alarm is thus appropriately raised based on the function of the standard deviation σ determined from data. Accordingly, the data management device is provided to facilitate setting of alarm standards and automatically control the central value.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an external view of a computer system implementing a quality control device according to one embodiment of the present invention.

FIG. 2 is a control block diagram of the computer system shown in FIG. 1.

FIG. 3 is a Shewhart control chart with its control based on deviation from the average.

FIGS. 4 and 5 are flowcharts showing a control structure of a program executed by the quality control device according to the embodiment of the present invention.

FIGS. 6-9 show distribution of data.

FIG. 10 shows a Shewhart control chart with its control based on deviation from the specification center.

### DESCRIPTION OF THE PREFERRED EMBODIMENTS

An embodiment of the present invention is now described in conjunction with the drawings. In the following description and drawings, the same components are denoted by the same reference character and have the same name and function, and detailed description thereof is not repeated here.

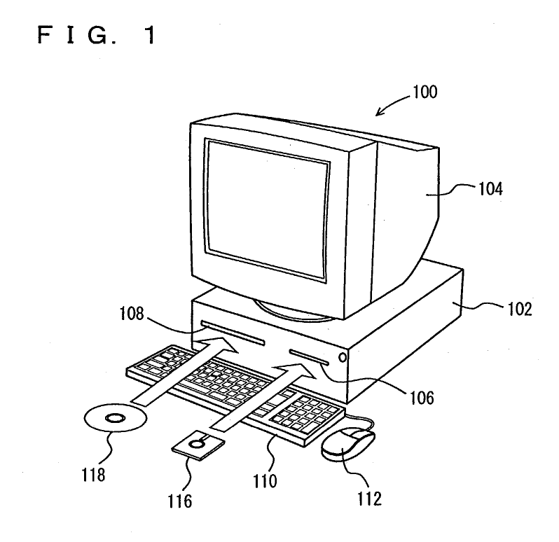

FIG. 1 shows an external view of a computer system as an exemplary quality control device. Referring to FIG. 1, computer system 100 includes a computer 102 having an FD (flexible disk) drive unit 106 and a CD-ROM (compact disc-read-only memory) drive unit 108, a monitor 104, a keyboard 110 and a mouse 112.

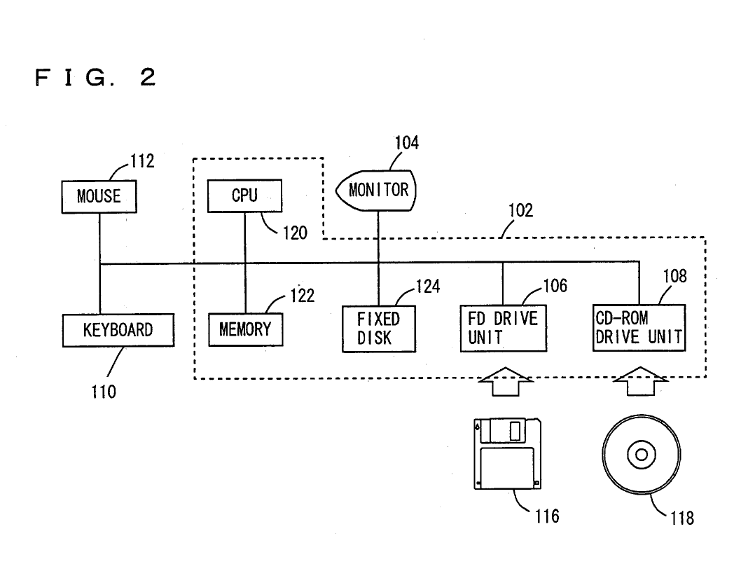

FIG. 2 shows a configuration of this computer system 100 in the form of a block diagram. Referring to FIG. 2, computer 102 includes, in addition to FD drive unit 106 and CD-ROM drive unit 108, a CPU (central processing unit) 120, a memory 122 and a fixed disk 124 connected to each other by a bus. An FD 116 is mounted on FD drive unit 106 and a CD-ROM 118 is mounted on CD-ROM drive unit 108.

The quality control device according to this embodiment is implemented by computer hardware and software executed by CPU 120. In general, such software is stored on such a recording medium as FD 116 or CD-ROM 118 and accordingly put on the market, and the software is read from the recording medium by FD drive unit 106 or CD-ROM drive unit 108 to be stored temporarily on fixed disk 124. Further, the software is read from fixed disk 124 onto memory 122 to be executed by CPU 120. The hardware of the computer shown in FIGS. 1 and 2 is a generally used one. The most essential part of the present invention is thus the software recorded on such recording media as FD 116, CD-ROM 118 and fixed disk 124.

The operation of the computer itself shown in FIGS. 1 and 2 is well-known and detailed description thereof is not repeated here.

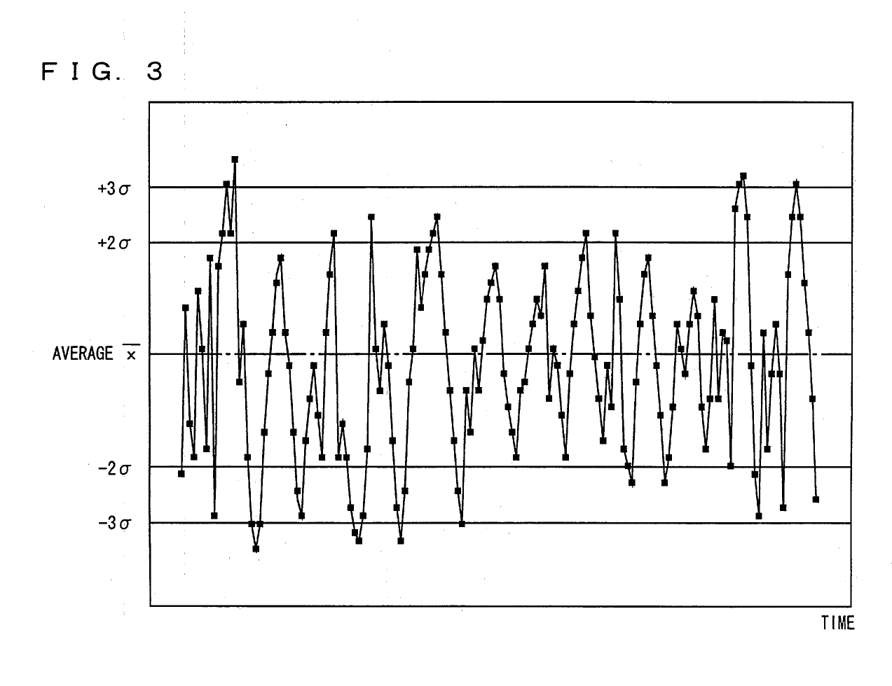

FIG. 3 shows a Shewhart control chart for data to be managed by the quality control device according to this embodiment. The data is of the thickness of a nitride film in a process of producing the nitride film. The central value in an allowable specification range (this central value is hereinafter referred to as “specification center”) is 85 Å. The horizontal axis and the vertical axis of the Shewhart control chart shown in FIG. 3 indicate time and thickness data respectively. It is seen from FIG. 3 that the thickness data disperses from the average as the center.

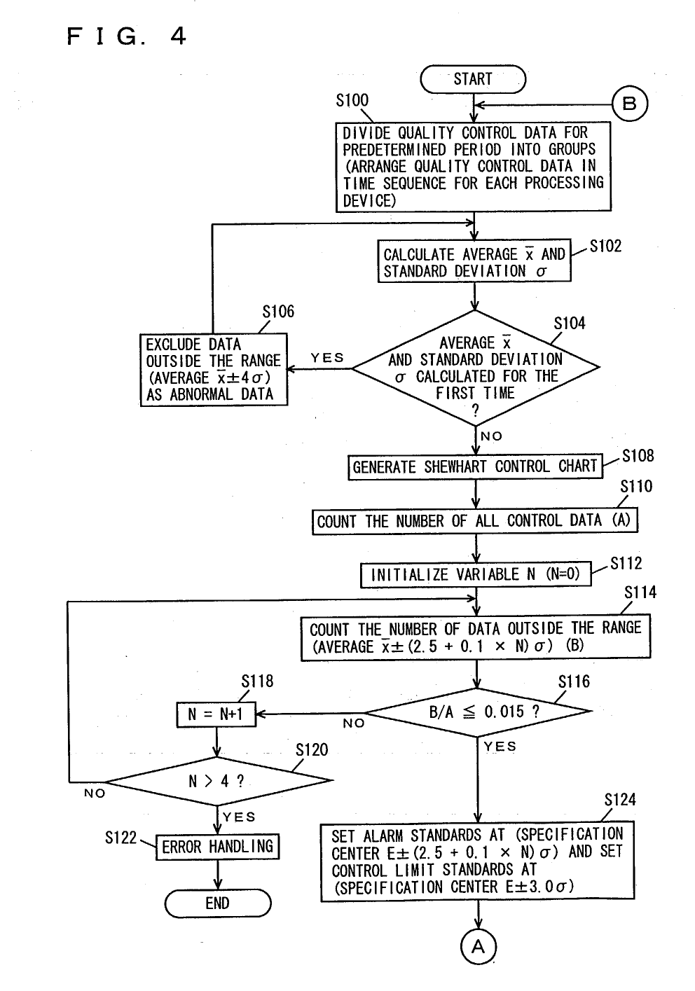

Referring to FIG. 4, a control structure of a program executed by the quality control device according to this embodiment is now described.

In step 100 (“step” is hereinafter abbreviated as S), CPU 120 of the quality control device divides quality control data (thickness data) for a predetermined period into groups. At this time, the quality control data are arranged in time sequence for each processing unit. In S102, CPU 120 calculates average X and standard deviation σ. In S104, CPU 120 determines whether or not the average X and standard deviation σ are calculated for the first time. If the average X and standard deviation σ are calculated for the first time (YES in S104), this procedure proceeds to S106. If not (NO in S104), the procedure proceeds to S108.

In S106, CPU 120 excludes data outside the range represented by (average X±4σ) as the data correspond to abnormal values. The procedure thereafter returns to S102 and average X and standard deviation σ are calculated again.

In S108, CPU 120 generates a Shewhart control chart as shown in FIG. 3. In S110, CPU 120 counts the number of all quality control data (A). Here, all the quality control data does not include the data (abnormal values) outside the range that has been excluded in S106.

In S112, CPU 120 initializes variable N (N=0). In S114, CPU 120 counts the number of data outside the range represented by (average X±(2.5+0.1×N)σ(B). In S116, CPU 120 determines whether or not the ratio of the number of data outside the range (B) relative to the number of all the quality control data (A), i.e., (B/A), is 0.015 or less. If the ratio (B/A) is 0.015 or less (Yes in S116), the procedure proceeds to S124. If not (NO in S116), the procedure proceeds to S118.

In S118, CPU 120 adds 1 to variable N. In S120, CPU 120 determines whether or not variable N is greater than 4. If variable N is greater than 4 (YES in S120), the procedure proceeds to S122. If not (NO in S120), the procedure returns to S114 and the number of data outside the range (B) is counted again for the variable N to which 1 is added.

In S122, CPU 120 handles the error. Through the error handling, an operator for example is informed of the fact that quality control cannot be executed since alarm standards reversed value with control-limit standards.

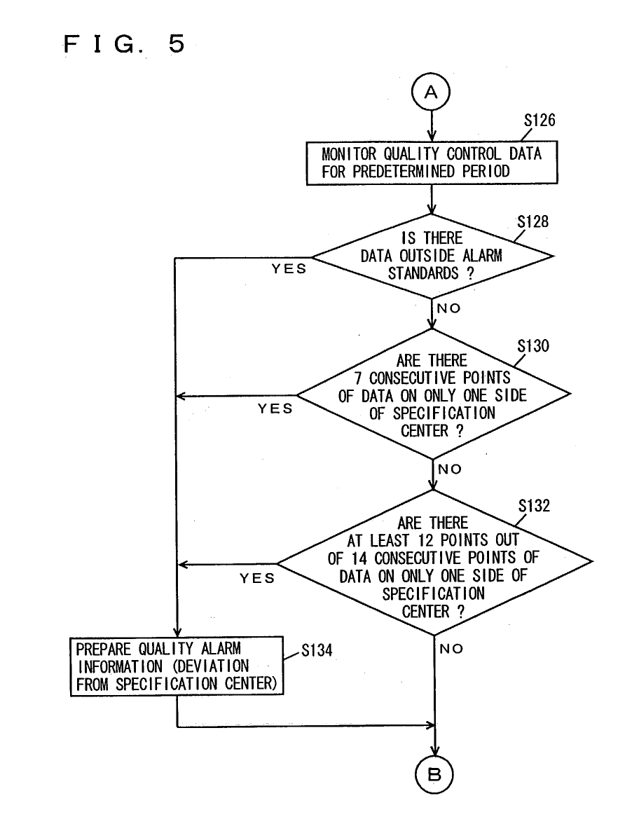

In S124, CPU 120 sets alarm standards at (specification center E±(2.5+0.1×N)σ, and sets control-limit standards at (specification center E±3.0σ). The procedure thereafter proceeds to S126 in FIG. 5.

Referring to FIG. 5, in S126, CPU 120 monitors quality control data (thickness data) for a predetermined period. In S128, CPU 120 determines whether or not any data is present outside the range of the alarm standard. If there is any data outside the range of the alarm standard (Yes in S128), the procedure proceeds to S134. If not (NO in S128), the procedure proceeds to S130.

In S130, CPU 120 determines whether or not seven consecutive points of the data are present on only one side of the specification center. If seven consecutive points of the data are present on only one side of the specification center (YES in S130), the procedure proceeds to S134. If not (NO in S130), the procedure proceeds to S132.

In S132, CPU 120 determines whether or not at least twelve points out of fourteen consecutive points of the data are present on only one side of the specification center. If at least twelve points out of fourteen consecutive points of the data are present on only one side of the specification center (YES in S132), the procedure proceeds to S134. If not (NO in S132) the procedure returns to S104 in FIG. 4.

In S134, CPU 120 prepares quality alarm information to inform the operator of the difference from the specification center. The operator receiving the quality alarm information adjusts any nitride-film producing device. After the process in S134, the procedure returns to S100 in FIG. 4.

An operation of the quality control device according to this embodiment is now described based on the above-discussed structure and flowcharts.

Quality control data for a predetermined period are divided into groups, and the quality control data are arranged in time sequence for each processing device (S100). At this time, the Shewhart control chart as shown in FIG. 3 is generated. Here, average X and standard deviation σ have not been calculated.

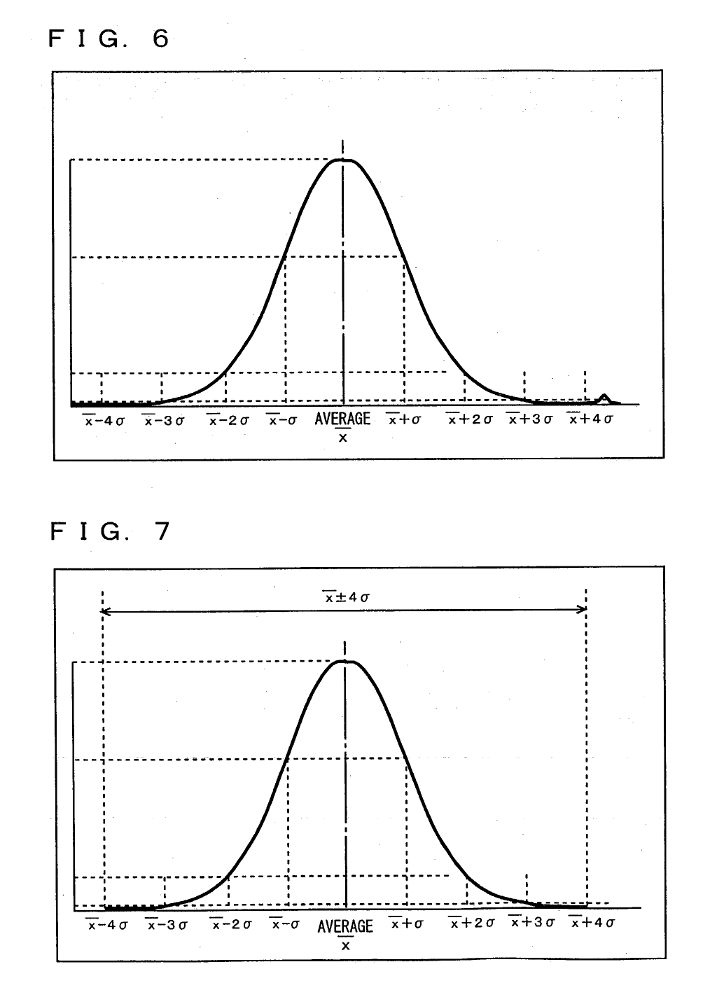

Then, the average X and standard deviation σ are calculated (S102). As the calculation is done for the first time (YES in S104), data outside the range represented by (average X±4σ) is regarded as abnormal values and accordingly excluded (S106). For example, data outside the limit (average X+4σ) is excluded as abnormal data as shown in FIG. 6. Then, as shown in FIG. 7, only the data within the range represented by (average X±4σ) is regarded and processed as all the quality control data. The number (A) of all the quality control data within the range (average X±4σ) shown in FIG. 7 is counted (S110). Here, average X shown in FIG. 6 is determined from data including the data outside and within the range (average X±4σ) while average X shown in FIG. 7 is determined from only the data within the range (average X±4σ).

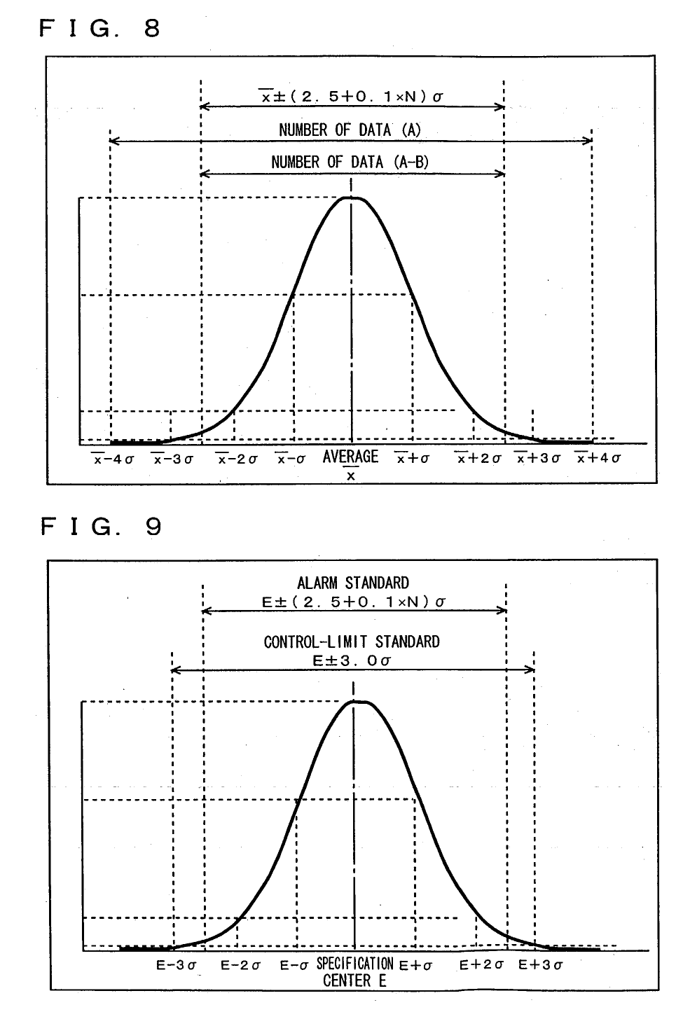

Variable N is initialized (N=0) (S112), and the number (B) of the data outside the range represented by (average X±(2.5+0.1×N)σ) is counted (S114). At this time, as shown in FIG. 8, the number (B) of the data outside respective limits (2.5+0.1×N)σ from the center corresponding to the average X is counted. 1 is added to variable N unless it is found that the ratio (B/A) of the number of the data outside the range (B) relative to the number of all the quality control data (A) is 0.015 or less (S118). It is noted that N never exceeds 4 (S120). N is thus determined so that the ratio of data outside the range (average X±(2.5+0.1×N)σ) is 0.015, i.e., 1.5%, with respect to all the quality control data.

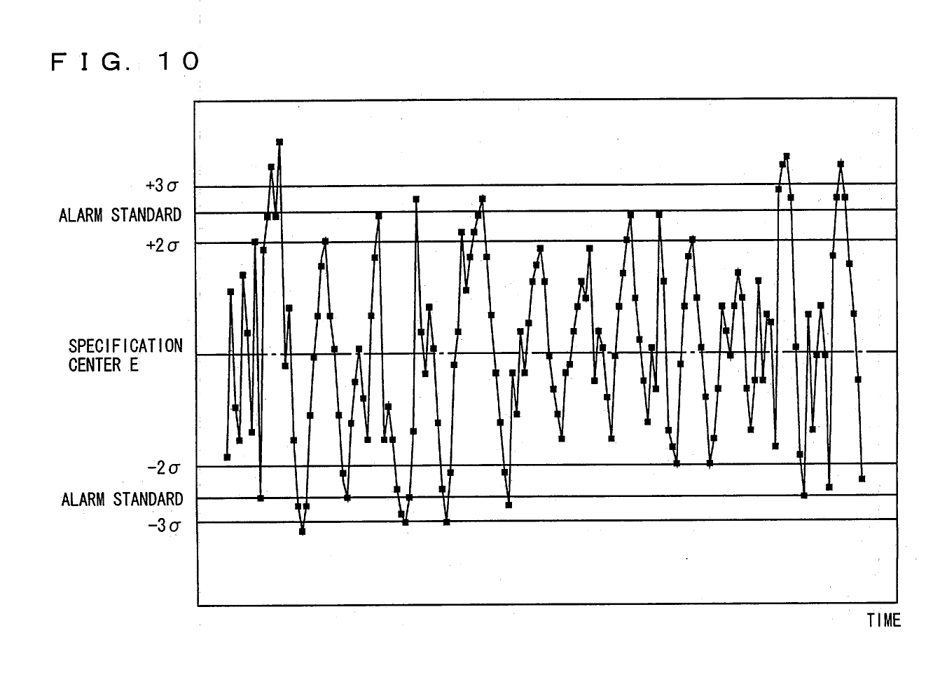

Alarm standards are set at (specification center E±(2.5+0.1×N)σ) and control-limit standards are set at (specification center E±3.0σ) (S124). At this time, the alarm standards and control-limit standards are set as shown in FIG. 9. Then, 98.5% of the data is included within the alarm standards and 99.73% of the data is included within the control-limit standards.

Quality control data for a predetermined period is monitored (S126). If there is found data outside the alarm standards (YES in S128), if seven consecutive points of the data are present on only one side of the specification center (YES in S130), or if at least twelve out of fourteen consecutive points of the data are present on only one side of the specification center (YES in S132), quality alarm information is prepared (S134). Here, as shown in the Shewhart control chart in FIG. 10, the alarm standards are set and the quality alarm information is produced if any data is present outside the alarm standards. In addition, the quality alarm information is produced if seven consecutive points of the data are present on the upper side of the specification center or if twelve out of fourteen consecutive points of the data are present on the upper side of the specification center.

As heretofore discussed, the quality control device according to this embodiment determines the region which corresponds to a part of all the data, the ratio of the partial data being a predetermined ratio (0.015) or less, and which is represented by the function of standard deviation σ with the average (X) of all the data as the center. The function of standard deviation σ((2.5+0.1×N)σ) is used for controlling the specification center, and alarms are issued according to the predetermined ratio. Then, alarms are appropriately given based on the function of standard deviation σ determined from data. It is thus facilitated to set alarm standards on the Shewhart control chart, and the central value can automatically be controlled.

It is noted that the ratio of the number of the partial data relative to the number of all the data is not limited to 0.015 and 0.045 as they are merely exemplary ones. In addition, according to the description above, an alarm is issued if seven consecutive points of the data or twelve out of fourteen consecutive points of the data are found on only one side of the specification center. The numbers here are not limited to those specific numbers, namely seven, twelve and fourteen.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data management device comprising:
storage means for storing data;
first calculation means for calculating average X, standard deviation σ and the number of all data except for abnormal data in said data stored by said storage means;
second calculation means for calculating the number of partial data of said all data, said partial data being outside a region of a range defined by a function of said standard deviation σ with said average X as a center;
third calculation means for calculating a function of said standard deviation σ representing a region where the ratio of the number of said partial data relative to the number of said all data is equal to a predetermined ratio or less; and
first output means monitoring measured data according to said calculated function of said standard deviation σ for outputting an alarm for said measured data.

2. The data management device according to claim 1, wherein
said calculated function of said standard deviation σ is represented by (2.5+0.1×N)×σ (N is 0 or natural number), and
said third calculation means includes means for calculating a function of said standard deviation σ representing a region where the ratio of the number of said partial data relative to the number of said all data is equal to 0.015 or less.

3. The data management device according to claim 1, wherein
said calculated function of said standard deviation σ is represented by (2.0+0.1×N)×σ (N is 0 or natural number), and
said third calculation means includes means for calculating a function of said standard deviation σ representing a region where the ratio of the number of said partial data relative to the number of said all data is equal to 0.045 or less.

4. The data management device according to claim 1, wherein
said first output means includes means for outputting an alarm for the measured data when new data is present outside a range of a region represented by said calculated function of said standard deviation σ with a central value of a specification range as a center.

5. The data management device according to claim 1, further comprising second output means for outputting an alarm notifying that there arises a variation in the data when a predetermined number of consecutive time-series data is present on only one of respective sides larger than and smaller than a central value of a specification range.

6. The data management device according to claim 1, further comprising second output means for outputting an alarm notifying that there arises a variation in the data when at least a predetermined number of consecutive time-series data is present on only one of respective sides larger than and smaller than a central value of a specification range.

7. A data management device comprising:
storage means for storing data;
first calculation means for calculating average X, standard deviation σ and the number of all data except for abnormal data in said data stored by said storage means;
second calculation means for calculating the number of partial data of said all data, said partial data being within a region of a range defined by a function of said standard deviation σ with said average X as a center;
third calculation means for calculating a function of said standard deviation σ representing a region where the ratio of the number of said partial data relative to the number of said all data is equal to a predetermined ratio or more; and
first output means monitoring measured data according to said calculated function of said standard deviation σ for outputting an alarm for said measured data.

8. The data management device according to claim 7, wherein
said calculated function of said standard deviation σ is represented by (2.5+0.1×N)×σ (N is 0 or natural number), and
said third calculation means includes means for calculating a function of said standard deviation σ representing a region where the ratio of the number of said partial data relative to the number of said all data is equal to 0.985 or more.

9. The data management device according to claim 7, wherein
said calculated function of said standard deviation σ is represented by (2.0+0.1×N)×σ (N is 0 or natural number), and
said third calculation means includes means for calculating a function of said standard deviation σ representing a region where the ratio of the number of said partial data relative to the number of said all data is equal to 0.955 or more.

10. The data management device according to claim 7, wherein
said first output means includes means for outputting an alarm for the measured data when new data is present outside a range of a region represented by said calculated function of said standard deviation σ with a central value of a specification range as a center.

11. The data management device according to claim 7, further comprising second output means for outputting an alarm notifying that there arises a variation in the data when a predetermined number of consecutive time-series data is present on only one of respective sides larger than and smaller than a central value of a specification range.

12. The data management device according to claim 7, further comprising second output means for outputting an alarm notifying that there arises a variation in the data when at least a predetermined number of consecutive time-series data is present on only one of respective sides larger than and smaller than a central value of a specification range.
